(19) United States
(12) Patent Application Publication
(10) Pub. No.: US 2020/0363208 A1
(43) Pub. Date: Nov. 19, 2020

(54) FACTORY-SPECIFIC INERTIAL MEASUREMENT UNIT ERROR MODEL

(71) Applicant: Honeywell International Inc., Morris Plains, NJ (US)

(72) Inventor: Tom Jakel, Minneapolis, MN (US)

(73) Assignee: Honeywell International Inc., Morris Plains, NJ (US)

(21) Appl. No.: 16/415,984

(22) Filed: May 17, 2019

(51) Int. Cl. G01C 21/16; G01S 19/04

(52) U.S. Cl. CPC G01C 21/165; G01S 19/04

(57) ABSTRACT

Systems and methods providing a factory-specific inertial measurement unit error model are described herein. In certain embodiments, a system includes a storage medium configured to store measurements received from one or more units located within a controlled environment, wherein the controlled environment provides environmental information about the environmental changes experienced by the one or more units. The system also includes a processing unit configured to execute code that causes the processing unit to calculate residuals based on the stored measurements and the provided environmental information. Additionally, the code causes the processing unit to calculate a stochastic model for the one or more units based on the calculated residuals and the provided environmental information, wherein the stochastic model is applied to the measurements of the one or more units.

### BACKGROUND

Inertial navigation systems may include multiple inertial sensors that provide inertial measurements that are useful for the calculation of navigation solutions for a moving object. However, inertial sensors may be subject to errors that may exist at the first turn on of the inertial sensor and errors that change and develop through the life of the inertial sensor. To account for the errors that may occur during the operation of an inertial sensor, deterministic inertial sensor models may be developed that account for some of the possible errors that arise during sensor operation.

### SUMMARY

Systems and methods providing a factory-specific inertial measurement unit error model are described herein. In certain embodiments, a system includes a storage medium configured to store measurements received from one or more units located within a controlled environment, wherein the controlled environment provides environmental information about the environmental changes experienced by the one or more units. The system also includes a processing unit configured to execute code that causes the processing unit to calculate residuals based on the stored measurements and the provided environmental information. Additionally, the code causes the processing unit to calculate a stochastic model for the one or more units based on the calculated residuals and the provided environmental information, wherein the stochastic model is applied to the measurements of the one or more units.

### DRAWINGS

Understanding that the drawings depict only some embodiments and are not therefore to be considered limiting in scope, the exemplary embodiments will be described with additional specificity and detail using the accompanying drawings, in which:

FIG. 1 is a block diagram illustrating an exemplary navigation system according to an aspect of the present disclosure;

FIG. 2 is a flowchart diagram illustrating an exemplary method for performing separate factory processes for a unit according to an aspect of the present disclosure;

FIG. 3 is a block diagram of a system for performing separate factory processes for a unit according to an aspect of the present disclosure;

FIG. 4 is a block diagram illustrating the calibration of multiple units according to an aspect of the present disclosure;

FIG. 5 is a block diagram illustrating the verification of the deterministic error models and calculation of a stochastic error model for multiple units according to an aspect of the present disclosure;

FIG. 6 is a diagram of a graph illustrating diurnal cycles when conducting performance maintenance and life testing according to an aspect of the present disclosure;

FIG. 7 is a flowchart diagram illustrating a method for calculating a stochastic model for in-run variation according to an aspect of the present disclosure;

FIG. 8 is a flowchart diagram illustrating a method for calculating a stochastic model for turn-on variation according to an aspect of the present disclosure;

FIG. 9 is a diagram illustrating the creation of stochastic models from gathered data according to an aspect of the present disclosure;

FIG. 10 is a flowchart diagram for creating factory-specific stochastic error models according to an aspect of the present disclosure.

In accordance with common practice, the various described features are not drawn to scale but are drawn to emphasize specific features relevant to the example embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made.

To more accurately model the operation of an inertial sensor, the inertial sensor model may be developed through tests performed at a factory. For example, an inertial sensor may be subjected to thermal tests, calibration, and verification processes for both the inertial sensor and a family of inertial sensors to which the inertial sensor belongs. These tests and processes may calibrate the inertial sensors for the various environments that the inertial sensor may experience. The tests and processes may provide residuals to the calibration that may be used by a processor to stochastically describe errors that arise in the operation of the inertial sensor.

Additionally, the factory processes may acquire details of performance degradation based on time, exposure to environments, and other factors that can be used to predict changes in inertial sensor errors that are based on known conditions. The known conditions may include the time since the inertial sensor left the factory, calibration information obtained from GNSS satellites, information from data connections, or known storage conditions from customer input. These inertial sensor error uncertainties may be fed into a stochastic estimator to predict the values based on independent measurements.

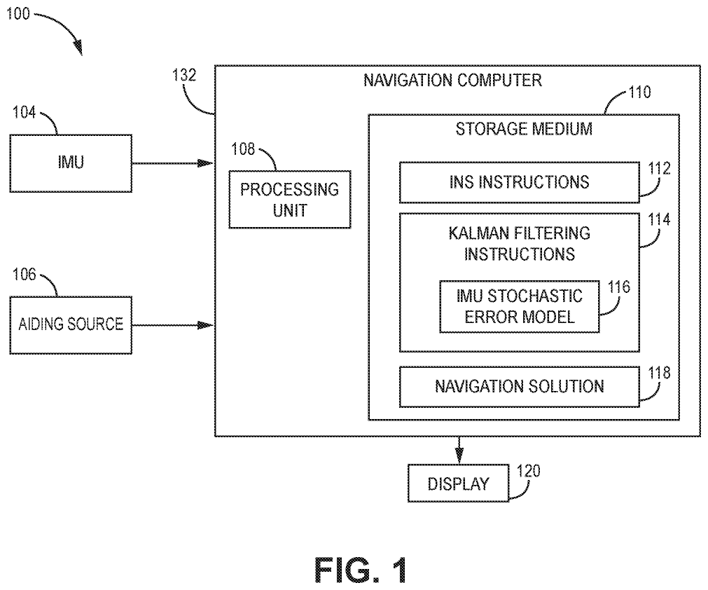

FIG. 1 is a block diagram of a navigation system 100 for calculating a navigation solution 118 for a vehicle, where the navigation solution 118 describes the position, attitude, heading, and velocity of the vehicle. In certain embodiments, the navigation system 100 includes an inertial measurement unit (IMU) 104. The IMU 104 may be a sensor device configured to sense motion and output data that corresponds to the sensed motion. In one embodiment, the IMU 104 comprises sets of gyroscopes and accelerometers that determine information about motion in any of six degrees of freedom (that is, lateral motion in three perpendicular axes and rotation about three perpendicular axes).

The navigation system 100 further includes a navigation computer 102 that receives measurements from the IMU 104 and uses the measurements to predict a navigation solution 118 for the vehicle. The navigation computer 102 includes one or more processing units 108 that process executable instructions and data received from external sensors to determine the navigation solution 118. In at least one embodiment, the navigation computer 102 includes a storage medium 110 for storing instructions processed by the processing unit 108 and data created during the processing of navigation data. The storage medium 110 comprises, in one implementation, a tangible non-transitory medium for storing machine readable data. Further, in at least one exemplary implementation, the navigation computer 102 provides the navigation solution 118 to a display 120 to provide information related to the current navigation solution 118 to a user who is navigating or travelling within a vehicle. For example, the display 120 may include one or more devices that include a touchscreen, a monitor, and the like.

In an example, the processing unit 108 may include a central processing unit (CPU), microcontroller, microprocessor (e.g., a digital signal processor (DSP)), field programmable gate array (FPGA), application specific integrated circuit (ASIC), or other processing device. The storage medium 110 may include any appropriate processor readable medium used for storage of processor readable instructions or data structures. Suitable processor readable media can include tangible media such as magnetic or optical media. For example, tangible media can include a conventional hard disk, compact disk (e.g., read only or re-writable), volatile or non-volatile media such as random access memory (RAM) including, but not limited to, synchronous dynamic random access memory (SDRAM), double data rate (DDR) RAM, RAMBUS dynamic RAM (RDRAM), static RAM (SRAM), etc.), read only memory (ROM), electrically erasable programmable ROM (EEPROM), and flash memory, etc. Suitable processor-readable media may also include transmission media such as electrical, electromagnetic, and digital signals, conveyed via a communication medium such as a network and/or a wireless link. Moreover, it should be understood that the processor readable media can be integrated into the navigation computer 102 as in, for example, RAM, or can be a separate item to which access can be provided to the navigation computer 102 as in, for example, portable media such as a compact disk or flash drive.

In certain embodiments, storage medium 110 includes inertial navigation system (INS) instructions 112. The INS instructions 112 directs processing unit 108 to predict states that describe the vehicle motion, where the states are used to calculate the navigation solution 118 from the measurements received from the IMU 104. For example, the INS instructions 112 may direct the processing unit 108 to use dead reckoning to calculate the navigation solution 118 from motion information received from the IMU 104. However, because the navigation solution 118 is calculated using dead reckoning, over time, errors in the calculation of the navigation solution 118 accumulate, causing the accuracy of the predicted states to drift away from the true state of the vehicle motion.

To correct the accumulation of errors that are inherent in dead reckoning calculations, the navigation system also includes an aiding source 106. The aiding source 106 is a sensor that acquires information about the position, attitude, velocity, and/or heading to bound the accumulating errors that result from calculating the navigation solution 118 using motion information from the IMU 104. For example, the aiding source 106 can be a GNSS receiver, a vision sensor, or the like. To correct the accumulating errors from the IMU 104 using measurements from the aiding source 106, the storage medium 110 may include Kalman filter instructions 114.

In certain embodiments, the Kalman filter instructions 114 direct the processing unit 108 to use a stored linear model and measurements from the aiding source 106 to update the navigation solution that is based on the measurements from the IMU 104. For example, the Kalman filter instructions 114 may use motion information from the IMU 104 to calculate a predicted navigation solution 118. However, as was stated above, navigation solutions calculated from measurements from IMU 104 slowly drift away from the true navigation solution for a vehicle. In contrast, the aiding source 106 provides position estimates that are accurate to within a certain range but are noisy within that range. In one exemplary embodiment, aiding source 106 is a GNSS receiver. The GNSS receiver provides noisy measurements that are accurate to within a few meters. Kalman filter instructions 114 direct processing unit 108 to blend the drifting measurements from IMU 102 and the noisy measurements from aiding source 106 to update and increase the accuracy of navigation solution 118.

As was stated, the Kalman filter implemented by the execution of Kalman filter instructions 114 implements a linear model that describes the motion of the vehicle, however the motion of the vehicle is not always linear and the measurements provided by the different sensors in the IMU may be subject to errors that exist during the operation of the particular sensors and may change throughout the lifespan of the respective sensors. To account for these errors, the Kalman filter instructions 114 may include a stochastic error model 116 that is used to model errors in the measurements provided by the sensors in the IMU 104. The stochastic error model 116 may be developed during factory testing processes that may be performed on the particular sensor or on similar sensors. During operation, the Kalman filter instructions 114 may use the stochastic error model to predict error values based on independent measurements from a sensor and other measurements about the sensor.

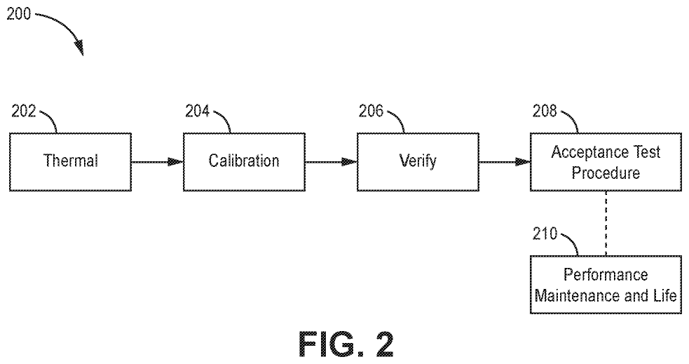

FIG. 2 is a high level flow diagram illustrating the separate factory processes 200 that are associated with the creation of a stochastic error model 116 for a particular unit, such as an inertial unit (such as a gyroscope or accelerometer), or other sensing unit. As shown, the separate factory processes 200 may include processes that are either performed on the unit while it is in the factory or performed on similar units, such as sensors that belong to the same family of sensors. For example, before an inertial sensor (or other unit type) is provided to a customer, the inertial sensor may undergo a thermal testing process 202, a calibration process 204, a verification process 206, and an acceptance test procedure 208. Additionally, the factory processes may include performing maintenance and life testing (PMLT) 210 on a unit in the family of the unit being provided to the customer or used for some other purpose outside the factory. During the performance of the various factory processes 200, information may be gathered that may be used for creating the stochastic error model 116 of FIG. 1 that may be loaded into the storage medium 110 of the navigation computer 102.

As stated above, the factory processes 200 may include a thermal testing process 202. In the thermal testing process 200, the performance of an uncalibrated unit under test is checked within a controlled environment. As used herein, a controlled environment may refer to an environment for a unit that has controlled thermal and motion conditions. For example, when the unit is an inertial sensor, the inertial sensor, within the controlled environment, may be subjected to known and controlled motion while experiencing controlled temperature changes. The temperature changes may be controlled by changing the temperature at certain rates or setting the temperature to certain desired temperatures within a range of temperatures. While the unit is subjected to the controlled motion and temperature changes, the motion information or other sensed characteristic measured and provided by the unit is stored along with information describing the actual motion experienced by the unit and the temperature information during the thermal testing process 202.

When the thermal testing process 202 is complete, the gathered measurements from the unit are compared against the known temperature and motion information experienced by the unit. The gathered information is used to create a model for the operation of the unit. For example, a model may be created using a least squares regression analysis to map the measurements from the unit to the known temperature and motion information. When the model is created, the factory processes 200 may proceed with the calibration 204 of the unit. For example, compensation coefficients from the model may be loaded onto the storage medium 110 within the navigation computer 102 in communication with the unit. The navigation computer 102 may use the coefficients and the measurements from the unit to estimate navigation information that more closely matches the actual state of the unit. Alternatively, compensating information from the model may also be directly loaded onto memory within the unit, such that the unit provides adjusted measurements.

In certain embodiments, when the unit has been calibrated, the factory processes 200 may continue. In particular, the factory processes 200 may verify 206 that the unit is calibrated, that is, that the calibration coefficients adjust the measurements provided by the unit such that the unit provides measurements that more accurately represent the environmental or motion characteristics being measured. To test the calibration, the unit may be put through thermal testing that is substantially similar to the thermal testing performed in the thermal testing process 202 described above. Accordingly, a testing system may verify 206 that the model accurately calibrates the operation of the unit such that the measurements provided by the unit reflect the actual temperatures, motion, or other environmental factors experienced by the unit.

In some embodiments, the factory processes 200 may also include PMLT 210. To perform the PMLT 210 for a unit, other similar units are brought through a life cycle of simulated aging tests. At intervals, the verify 206 test may be performed on the other units to determine how the operational characteristics of the unit have changed with time. Information may be gathered and from this information, the unit may be updated to account for changes in the operation of the sensor that may occur over the life cycle of the unit. Additionally, the data acquired through the PMLT 210 may be combined with the data gathered through the verification 206 to create a more accurate stochastic model for the operation of the unit.

In further embodiments, when the PMLT 210 information has been combined with the verification data create a stochastic model, the unit may undergo acceptance test procedures 208. During the acceptance test procedures 208, the coefficients and customer specific messages may be checked. In some implementations, the coefficients and messages may be checked at room temperature.

Typically, after the unit is verified, there may be some errors remaining. These residuals may be used for a stochastic in-run model and the family aging model from the PMLT 210 may be over bound to create a stochastic turn-on bias model for the family of units that can be used in a Kalman filter, such as the Kalman filter implemented by the Kalman filter instructions 114. Accordingly, the inertial sensor model may be well understood based on the factory processes, however, the information acquired from the testing may be used to better assess and predict the probabilistic error associated with each individual inertial sensor. For example, the calculated residuals from the verification of the unit may be used to seed the initial sensor error estimates for the Kalman filter and in-run bias variation. Further, the aging rate data acquired from the PMLT 210 along with the time since the unit left the factory may be used to compute the initial uncertainty for the turn-on bias. Accordingly, the inertial sensor errors may be more accurately estimated, leading to increased navigation performance.

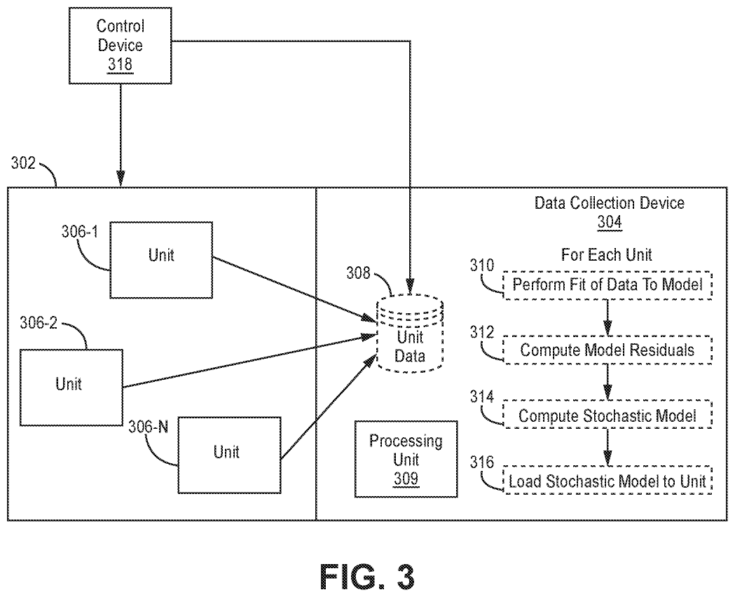

FIG. 3 is a block diagram of a system 300 for performing some of the steps described above with respect to the factory processes 200 in FIG. 2. For example, the system 300 is able to perform the thermal testing 202, calibration 204, and verification 206. In some embodiments, the system 300 may also perform a PMLT 210 on different devices within a family of units.

In certain embodiments, to perform the various factory processes 200, the system 300 may include a controlled environment 302. The controlled environment 302 may be controlled by a control device 318 or series of devices that controls the environmental changes experienced by one or more units 306 under test within the controlled environment 302. For example, the control device 318 may control environmental changes such as controlling the temperature, rate of temperature change, and the direction of temperature change experienced by the units 306 within the controlled environment 302. Additionally, the control device 318 that manages the controlled environment 302 may also control the environmental changes that affect the motion experienced by the units 306 within the controlled environment 302. For example, the control device 318 may control the rate of rotation experienced by the units 306 and the acceleration experienced by the units 306. In some implementations, the controlled environment 302 may be within a movable chamber, where the units 306 are placed inside the chamber. As the movable chamber moves around or as the temperature changes within the chamber, the units 306 may provide measurements of sensed motion or other environmental characteristics.

In some embodiments, the units 306 may be communicably connected to a unit data storage device 308 on a data collection device 304. The unit data storage device 308 may be one or more devices that can communicably receive information measured by the units 306 and store the information on a storage medium, wherein the storage medium is capable of storing data in a similar manner to the storage medium 110 in FIG. 1. For example, as the one or more units 306 experiences motion within the controlled environment 302, the one or more units 306 may provide measurements of the motion. As the units 306 are connected to the unit data storage device 308, the unit data storage device 308 may record the measurements received from the one or more units 306.

Also, the unit data storage device 308 may receive information from the control devices 318 that control the controlled environment 302. For example, the unit data storage device 308 may receive information about the temperature, the rate of change for the temperature, the acceleration and rate of rotation at different locations within the controlled environment 302, the units 306 located at the different locations within the controlled environment 302, sensor motor drive characteristics, time from start of run, magnetic fields, acoustic noise, and other environmental and operational characteristics that could affect the operation of the units 302.

In further embodiments, the unit data storage device 308 may store the information from the control devices 318 and the units 306 on tangible media in a similar manner to the storage medium 110 described above in FIG. 1. For example, the tangible media of the unit data storage device 308 may include a conventional hard disk, compact disk (e.g., read only or re-writable), volatile or non-volatile media such as random access memory (RAM) including, but not limited to, synchronous dynamic random access memory (SDRAM), double data rate (DDR) RAM, RAMBUS dynamic RAM (RDRAM), static RAM (SRAM), etc.), read only memory (ROM), electrically erasable programmable ROM (EEPROM), and flash memory, etc. The unit data storage device 308 may also store the gathered information on other suitable processor-readable media that may also include transmission media such as electrical, electromagnetic, and digital signals, conveyed via a communication medium such as a network and/or a wireless link. Moreover, it should be understood that the processor readable media can be integrated into the data collection device 304 as in, for example, RAM, or can be a separate item to which access can be provided to the data collection device 304 as in, for example, portable media such as a compact disk or a flash drive.

In further embodiments, when the data collection device 304 has acquired the data from the units 306 and the control device 318, a processing unit 309 may execute computer instructions that direct the processing unit 309 to analyze the data stored on the unit data storage device 308. The processing unit 309 may be similar to the processing unit 108 described above in FIG. 1. Further, in some implementations, the data collection device 304 may function as the control device 318 and the processing unit 309 may execute instructions that cause the processing unit 309 to control the operation of, or function as, the control device 318.

In certain embodiments, when executable instructions direct the processing unit 309 on the data collection device 304 to analyze the gathered information describing the operational environment of the units 306 and the measurements from the units 306, the processing unit 309 on the data collection device 304 may execute several method steps for each individual unit 306. For example, executable instructions may direct the processing unit 309 to perform a fit of the gathered data to a model at 310. Additionally, executable instructions may direct the processing unit 309 to computer model residuals at 312. Further, the executable instructions may direct the processing unit 309 to compute a stochastic model at 314. Moreover, the executable instructions may direct the processing unit 309 to load the computed stochastic model to the specific unit at 316. The process of calculating the stochastic model from the gathered data is described in greater detail below.

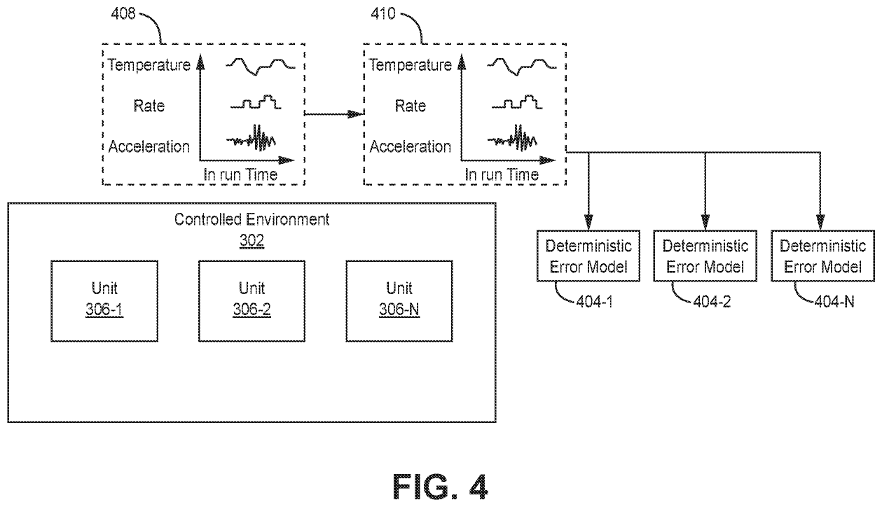

FIG. 4 is a block diagram illustrating the calibration of multiple units 306 during a factory verification process. As described above, the processing unit 309 of the data collection device 304 may perform the fit of the gathered data to a model at 310. Further, when calibrating the operation of the units 306, the calculated model may be installed on the particular unit 306.

As described above, separate units 306-1-306-N may be placed at particular locations within a controlled environment 302. When secured within the controlled environment 302, the units 306-1-306-N may be subjected to controlled environmental changes such as controlled temperature changes and controlled movements. In response to the controlled environmental changes, the units 306-1-306-N may provide measurements. For purposes of creating a model for the operation of the units 306-1-306-N, the controlled environmental changes experienced by the units 306-1-306-N within the controlled environment 302 may be considered known inputs 408 and the measurements provided by the units 306-1-306-N may be outputs 410.

In certain embodiments, when performing the fit of the gathered data to the model at 310 of FIG. 3, the processing unit 309 may fit the known inputs 408 to the outputs 410 separately for each of the units 306-1-306-N to create a deterministic error model 404-1-404-N for each of the units 306-1-306-N. To fit the inputs 408 to the outputs 410, the processing unit 309 may use methods such as least-squares regression or other data fitting methods used to model data. When the model is created from the input 408 and the outputs 410. The processing unit 309 may then make the deterministic error models 404-1-404-N available for loading onto the associated unit 306-1-306-N.

In some embodiments, the deterministic error models 404-1-404-N may include coefficients that are loaded directly onto the units 306-1-306-N. During operation of the units 306-1-306-N, the coefficients may be applied to measurements before the measurements are provided to the devices in communication with the units 306-1-306-N. Alternatively, the model may be provided to other devices that are in communication with the units 306-1-306-N, such that the other devices are able to accurately adjust raw measurements provided by the units 306-1-306-N. Accordingly, using information describing the known environmental inputs and the received measurements of the units 306 in response to the units, individual models may be created for adjusting the performance of the units 306 and increasing the accuracy of the units 306.

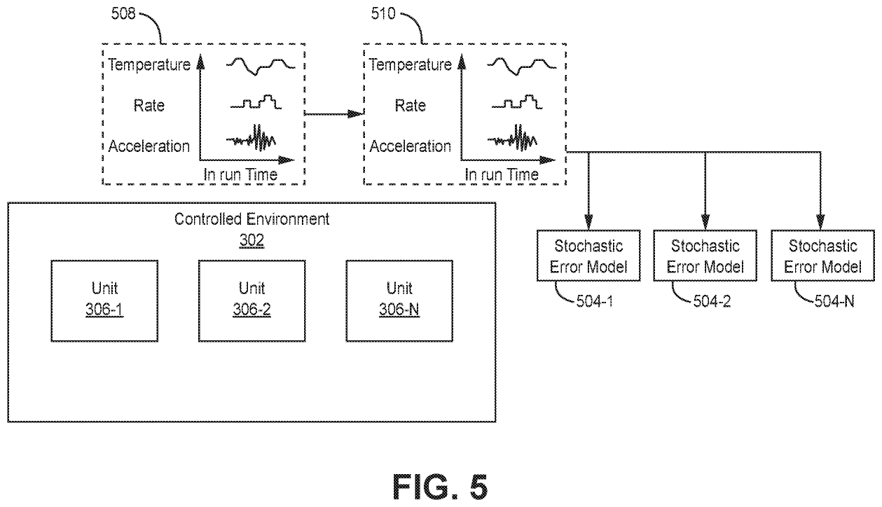

FIG. 5 is a block diagram illustrating the verification of the deterministic error models 404 developed for the separate units 306 described above with respect to FIG. 4. As described above with respect to the verify step 206, the verification step is performed to verify that the deterministic error model 404 causes the units 306 to make more accurate measurements. For example, where a unit is a gyroscope, the deterministic error model 404 may be loaded onto a controller for the gyroscope to verify that the deterministic error model 404 improves the accuracy of the unit 306 when the unit 306 is rotated.

In certain embodiments, to perform the verification of the deterministic error model, the deterministic error model 404 may be loaded onto the separate units 306 or otherwise applied to the measurements produced by the units 306. When the deterministic error model 404 is loaded onto the separate units, the separate units 306 may be placed back in the controlled environment 302. Within the controlled environment 302, the units 306 are again subjected to various environmental changes. For example, within the controlled environment 302, the units 306 may experience rotation, acceleration, different temperatures, different temperature changes, among other environmental inputs. In some embodiments, the units 306 may experience the same environmental inputs within the controlled environment 302 that were experienced by the units 302 during the calibration to create the deterministic error model 404. Alternatively, the units 306 may experience different environmental inputs within the controlled environment 302 than those experienced by the units 302 during the calibration.

In some embodiments, during the verification test, the known environmental inputs 508 and received measurement outputs 510 are recorded. For example, a unit data storage device 308 may be used to store the known environmental inputs 508 and the received measurement outputs 510 while the verification test is performed. Using the recorded inputs 508 and outputs 510, a processing unit 309 may calculate model residuals. As used herein, a model residual may refer to an error in the outputs 510 that is not compensated for by the deterministic error model 404. Using these model residuals, the processing unit 309 or some other computational device may compute a series of stochastic error models 504 for the respective operation of the units 306.

As used herein, a stochastic error model 504 may refer to a model that estimates probability distributions for potential outputs 510 by allowing for random variation in one or more inputs 508. For example, when a unit 306 is an accelerometer and the output 510 is a measurement of the acceleration experienced by the unit 306. A processing unit 309 may use a stochastic error model 504 to process several measured inputs 508 and calculate an expected value for the error in the provided acceleration measurement. The processing unit 309 may use a different stochastic error model 504 to calculate an expected value for the error in a provided measurement for other types of units 306, like gyroscopes or other measuring devices.

In some embodiments, the processing unit 309 may use the stochastic error model 504 to provide an expected value for the error based on receiving one or more inputs 508. These inputs may include one or more of temperature, measured rate of rotation, measured acceleration, temperature rate of change, sensor motor drive characteristics, time from start of run, time since deterministic model computed for similar inputs, magnetic field, acoustic noise, among other measurable inputs. The processing unit 309 may use the stochastic error model 504 to map the measured inputs 508 to an expected value for the error associated with the measurements.

In certain embodiments, when the processing unit 309 has calculated the stochastic error model 504 for a particular unit 306, the stochastic error model 504 may be loaded onto the unit 306 or otherwise applied to the measurements provided by the unit 306. For example, the processing unit 309 may compute stochastic error models 504-1-504-N where each of the stochastic error models 504-1-504-N are respectively associated with the units 306-1-306-N. Accordingly, the stochastic error models 504-1-504-N may be loaded onto the respective units 306-1-306-N or provided to another computational device for adjusting the measurements provided by the units 306-1-306-N. When a stochastic error model 504 is loaded onto a unit 306, the unit 306 may be submitted for acceptance tests and deployed for use, where the stochastic error model 504 augments the accuracy of the unit 306 during operation.

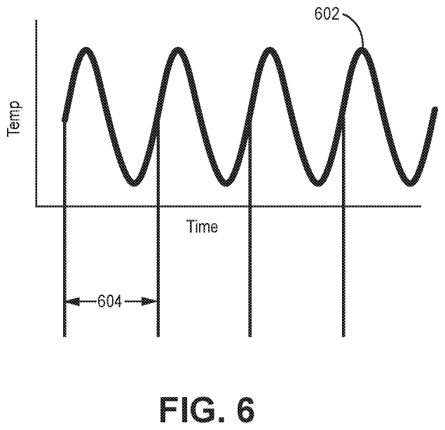

FIG. 6 is a graph showing a diurnal cycle applied to other units in the family of a unit 306. As described above, in parallel to the calibration and verification processes described above, other units in the family of the unit 306 may be subjected to PMLT. In certain embodiments, the PMLT may include one or more dedicated units that are in the family of a unit 306 that are brought through a life full of simulated aging. For example, the simulated aging may be performed by cycling the temperature 602 experienced by the one or more units through diurnal cycles 604, where the diurnal cycles 604 have a duration substantially less than the duration of a day.

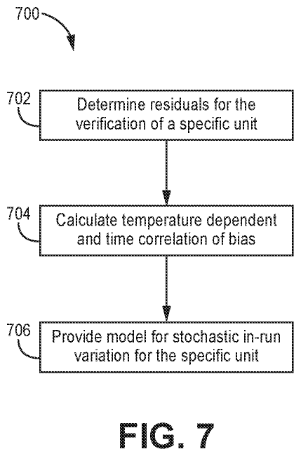

FIG. 7 is a flowchart diagram illustrating a method 700 for calculating and using a stochastic model to calculate an expected value for in-run variation. As used herein, in-run variation may refer to the variation in the error of provided measurements during the operation of the unit. For example, the in-run variation may be caused by temperature, time, stress, or other environmental and operational factors. To account for the in-run variation, a stochastic model of the in-run variation may be developed using the methods and systems described above.

In certain embodiments, the method 700 proceeds at 702, where thermal residuals are determined for the verification of a specific unit 306. For example, as described above, when a unit 306 has been calibrated and gone through the verification process, the outputs provided by the unit 306 under test may be different from the expected outputs based on the verification test inputs. The residuals may be calculated based on the difference between the output provided by the unit 306 and the expected outputs. When the thermal residuals are determined, the method 700 may proceed at 704, where temperature dependent and time correlation of the bias is calculated. For example, the processing unit 309 may identify statistical dependencies between the verification test inputs and the output provided by the unit 306. When the temperature dependent and time correlation of the bias is calculated, the method 700 may proceed at 706, where a model is provided for stochastic in-run variation for the unit 306. For example, the processing unit 309 may calculate a stochastic model that is dependent on measurable environmental factors that may affect the operation of the unit 306 during operation of the unit 306. The stochastic model may then be loaded onto the unit 306, where the stochastic model helps correct in-run bias that occurs due to environmental changes and other factors. Accordingly, the use of a stochastic model may help correct residual bias during the operation of the unit 306.

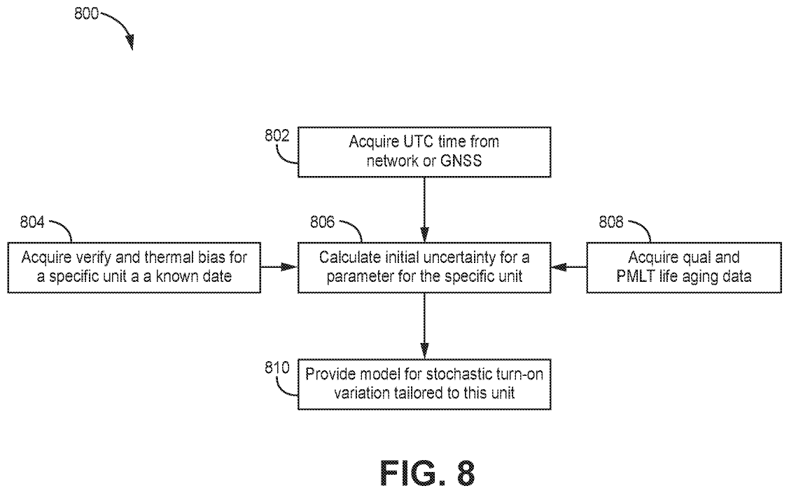

FIG. 8 is a flow chart diagram illustrating a method 800 for providing a stochastic model for turn-on variation for a particular unit 306. As described herein, the turn-on variation may refer to a bias that may exist during powerup of the unit 306. The turn-on variation may be caused by changes in the physical characteristics of the unit 306 and differing initial conditions when the unit 306 is powered up. The magnitude of the turn-on variation affects the ability of the unit 306 to converge on an estimate of the bias.

In certain embodiments, to account for the turn-on variation, the method 800 may acquire various inputs to construct a unit specific stochastic model for an initial parameter. For example, the method 800 may proceed at 802, where UTC time is acquired from a network or global navigation satellite system. Additionally, the method may proceed at 804, where verify and thermal bias are acquired for a specific unit 306 at a known date. Further, the method may proceed at 808, where quality and PMLT life aging data are acquired.

The method 800 may perform 802, 804, and 808 once, simultaneously, serially, or periodically according to the characteristics of the data acquired. For example, the verify and thermal bias may be acquired for a specific unit 306 when the verification test is performed for the unit 306. Also, during the calibration of the unit 306, the PMLT data for the unit 306 may be acquired from PMLT testing performed on similar units. Additionally, a unit 306 may acquire updated PMLT data when a unit 306 is operable. Further, the unit 306 may periodically acquire the UTC time.

When the unit 306, or a processing unit 309 associated with the unit 306 has acquired data from the various described sources, the method 800 may proceed at 806, where a unit specific calculation is performed for an initial uncertainty for a particular parameter. For example, a unit 306 may use the verification test data for the unit 306 to establish a beginning of life time. Then, using the UTC time, the unit 306 may determine the time since the verification test was performed or the age of the unit 306. Using the age of the unit 306, the unit 306 may use the PMLT data that is most pertinent to the determined age of the unit 306. When the unit 306 identifies the PMLT data that is pertinent to the current age of the unit 306, the unit 306 or a processing unit 309, may determine the turn-on uncertainty for the parameter being measured by the unit 306. When the turn-on uncertainty is calculated for the parameter, the method 800 may proceed at 810, where a model for the stochastic turn-on variation is provided that is tailored to the unit 306. For example, using the verify and thermal information in conjunction with the PMLT data, the unit 306 or a processing unit 309 may create a stochastic model that more accurately provides measurements of the turn-on variation.

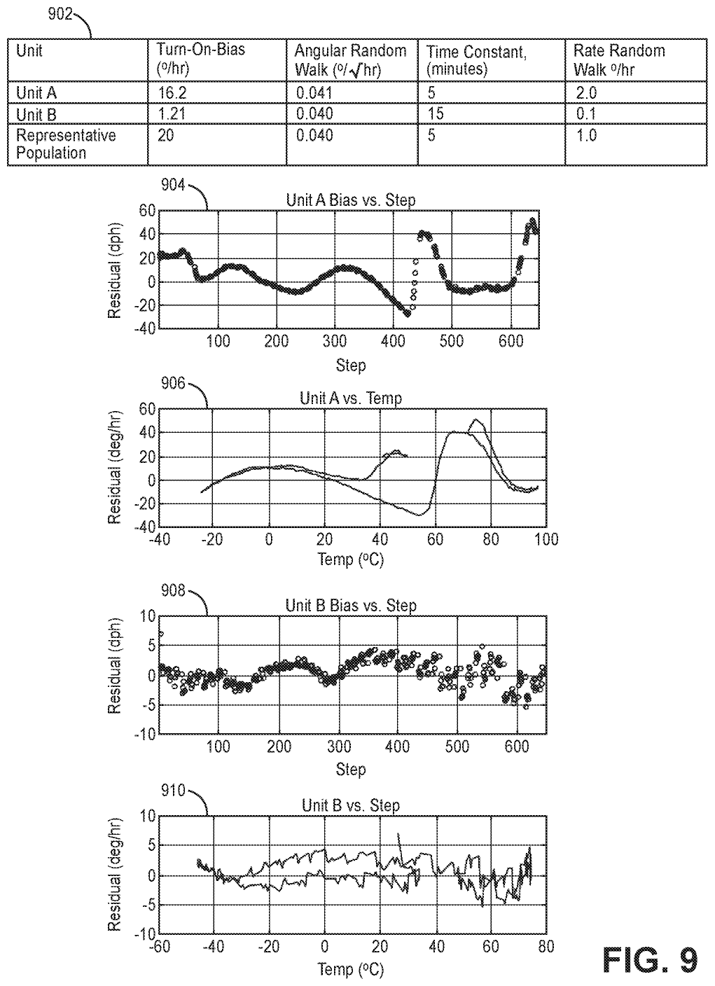

FIG. 9 is a diagram illustrating data gathered for the computation of a stochastic model and the outputs from calculated stochastic models for various errors that arise during the operation of different inertial measurement units. The provided stochastic models are examples of stochastic models and are provided to illustrate how stochastic models can be used to improve the accuracy of unit operation during the life of the unit.

As shown, FIG. 9 shows multiple graphs 902, 904, 906, and 908 that illustrate different measurements for multiple units 306. For example, graph 902 illustrates the residual bias in measurements provided by a Unit A at certain steps during the calibration process. As referred to herein and illustrated within FIG. 9, a step may refer to an increment in time or other quantifiable value. For example, a step may be time correlated, such that each step corresponds to a particular period of time. In particular, after a deterministic model is loaded onto the Unit A, the Unit A is subjected to a verification test. At certain time steps, the measurements provided by the Unit A are saved and compared against the expected measurements. The residual at the different time steps may be the difference between the provided measurements and the expected measurements at the different time steps. The residual bias at certain time steps may be calculated in a similar manner for multiple units. For example, graph 908 illustrates the residual bias at different time steps for a Unit B.

Further, FIG. 9 shows a graph 906 that illustrates the residuals for the Unit A vs temperature. As shown, the residual error for the measurements provided by the Unit A may change based on the environmental temperature. For example, when the environmental temperature was −20° C., a residual may be calculated based on the measurements provided by the Unit A as compared against the expected measurements based on the motion experienced by the Unit A. The temperature may then be increased and the residual may be calculated at different temperatures. When the temperature has been increased through a testing temperature range, the temperature may then be decreased and the residuals may be calculated again at the different temperatures. At each temperature, as the temperature moves through the temperature range, the temperature is either increasing or decreasing. In some implementations, the calculated residual may depend on whether the temperature is increasing or decreasing. Accordingly, for many of the different temperatures, the graph 906 shows multiple calculated residuals, where one residual is associated with a temperature while the temperature was increasing and the other residual is associated with a temperature while the temperature was decreasing. In a similar manner, graph 908 illustrates the calculated residuals at different temperatures for a Unit B.

From the calculated residual data for the time and temperature, and/or other measurable inputs, a processing unit 309 may calculate a stochastic model to determine the expected value for various errors that may arise during the operation of a unit 306, such as an inertial sensor. For example, the table 902 illustrates various stochastically modeled errors for both Unit A and Unit B. For example, the table 902 illustrates stochastically modeled values for the turn-on bias, the angular random walk, and the rate random walk, along as a time constant in minutes for Units A and B.

As used herein, and as described above, the turn-on bias is the initial value of the output of the unit 306 when the unit 306 is not sensing motion. For example, when the unit 306 is a gyroscope, the turn-on bias is the initial value of the measured rotation rate provided by the gyro when the gyro is sensing zero rotation. Similarly, when the unit 306 is an accelerometer, the turn-on bias is the initial value of the measured acceleration provided by the accelerometer when the accelerometer is sensing zero acceleration. In one particular example, the turn-on bias may be a combination of data gathered through the verification of the unit 306 plus the population average acquired from PMLT data. For example, as shown, in the table 902, where the units are gyroscopes, the turn-on bias for Unit A may be 16.2°/hr and the turn-on bias for Unit B may be 1.21°/hr. Also, the turn-on bias for the representative population may be 20°/hr. Accordingly, the turn-on bias for the different units may be averaged with the turn-on bias for the representative population.

In some embodiments, a processing unit 309 may also calculate the angular random walk for a particular unit 306, where the unit is a gyroscope. As used herein, the angular random walk may be the integrated error due to white noise in the measurements provided by the gyroscope. It may be approximated by σ_{θ}=σ\sqrt{Δt*t|ₜ₌₁} where σ is in units of °/√hr. For example, as shown, in the table 902, where the units 306 are gyroscopes, the angular random walk for Unit A may be 0.041°/√hr and the angular random walk for Unit B may be 0.040°/√hr. Also, the angular random walk for the representative population may be 0.040°/√hr.

Additionally, a processing unit 309 may also calculate the rate random walk for a particular unit 306, such as a gyroscope. As used herein, the rate random walk may be the expected difference in the value of a gyroscope output at two different times separated by a time constant. For example, the expected difference may be calculated using the equation E(B_{ω}|ₜ_{₀}−B_{ω}|_{t+τ}), where B_{ω}, is the output of the gyroscope and τ is the time constant. For example, as shown in the table 902, the rate random walk for Unit A may be 2.0°/hr and the rate random walk for Unit B may be 0.1°/hr. Additionally, the rate random walk for the representative population may be 1.0°/hr. As such, using the residual computations based on temperature and time, a processing unit 309 may calculate a stochastic model for a particular unit 306.

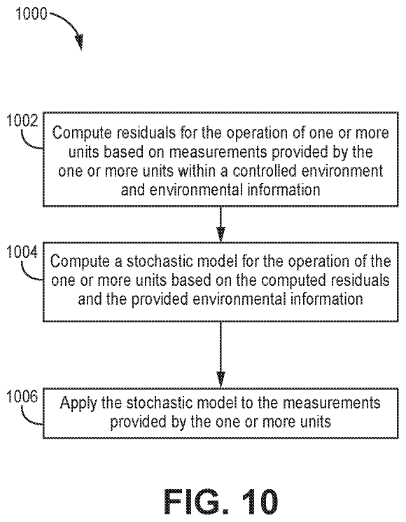

FIG. 10 is a flowchart diagram illustrating a method 1000 for computing a stochastic model during a factory-specific process. In certain embodiments, the method 1000 begins at 1002, where residuals for the operation of one or more units are computed based on measurements provided by the one or more units within a controlled environment 302 and environmental information. Additionally, the method 1000 proceeds at 1004, where a stochastic model is computed for the operation of the one or more units based on the computed residuals and the provided environmental information. Further, the method 1000 proceeds at 1006, where the stochastic model is applied to the measurements provided by the one or more units.

### EXAMPLE EMBODIMENTS

Example 1 includes a system comprising: a storage medium configured to store measurements received from one or more units located within a controlled environment, wherein the controlled environment provides environmental information about the environmental changes experienced by the one or more units; and a processing unit configured to execute code that causes the processing unit to: calculate residuals based on the stored measurements and the provided environmental information; and calculate a stochastic model for the one or more units based on the calculated residuals and the provided environmental information; wherein the stochastic model is applied to the measurements of the one or more units.

Example 2 includes the system of Example 1, wherein the processing unit is further configured to execute code that causes the processing unit to compute a deterministic model based on the stored measurements and the provided environmental information, wherein the one or more units are calibrated using the deterministic model and the residuals are calculated based on measurements provided by the calibrated one or more units.

Example 3 includes the system of any of Examples 1-2, wherein the stochastic model provides an expected value for at least one of: in-run variation; and turn-on variation.

Example 4 includes the system of Example 3, wherein the stochastic model for the in-run variation is calculated based on a temperature dependency for the in-run variation and a correlation of the in-run variation with time.

Example 5 includes the system of any of Examples 3-4, wherein the stochastic model for the turn-on variation is calculated based on: the residuals calculated at a known time; a current time; and performance maintenance and life testing (PMLT) data gathered from other units belonging to the family of the one or more units.

Example 6 includes the system of any of Examples 1-5, wherein the one or more units are at least one of: a gyroscope; and an accelerometer.

Example 7 includes the system of any of Examples 1-6, wherein the environmental information describes at least one of: an environmental temperature; a rate of environmental temperature change; a rate of acceleration; and a rate of rotation.

Example 8 includes the system of Example 7, wherein the stochastic model is further calculated based on at least one of: a measurement of sensor motor drive characteristics; a time from start of operation for the one or more units; a magnetic field measurement; an acoustic field measurement; and a time since computation of a deterministic model for the one or more units.

Example 9 includes a method comprising: compute residuals for the operation of one or more units based on measurements provided by the one or more units within a controlled environment and environmental information about the environmental changes experienced by the one or more units; compute a stochastic model for the operation of the one or more units based on the computed residuals and the provided environmental information; and apply the stochastic model to the measurements provided by the one or more units.

Example 10 includes the method of Example 9, further comprising computing a deterministic model based on the stored measurements and the provided environmental information.

Example 11 includes the method of Example 10, wherein computing residuals for the operation of the one or more units comprises: calibrating the one or more units using the deterministic model; and comparing measurements provided by the calibrated one or more units and expected measurements based on the environmental changes.

Example 12 includes the method of any of Examples 9-11, wherein the stochastic model provides an expected value for at least one of: in-run variation; and turn-on variation.

Example 13 includes the method of Example 12, wherein computing the stochastic model for the in-run variation comprises calculating the stochastic model based on a temperature dependency for the in-run variation and a correlation of the in-run variation with time.

Example 14 includes the method of any of Examples 12-13, wherein computing the stochastic model for the turn-on variation comprises calculating the stochastic model based on: the residuals calculated at a known time; a current time; and performance maintenance and life testing (PMLT) data gathered from other units belonging to the family of the one or more units.

Example 15 includes the method of any of Examples 9-14, wherein the one or more units are at least one of: a gyroscope; and an accelerometer.

Example 16 includes the method of any of Examples 9-15, wherein the environmental information describes at least one of: an environmental temperature; a rate of environmental temperature change; a rate of acceleration; and a rate of rotation.

Example 17 includes the method of Example 16, wherein computing the stochastic model is based on at least one of: a measurement of sensor motor drive characteristics; a time from start of operation for the one or more units; a magnetic field measurement; an acoustic field measurement; and a time since computation of a deterministic model for the one or more units.

Example 18 includes a system comprising: a controlled environment containing one or more units, wherein the one or more units are exposed to environmental changes and the one or more units provide measurements while experiencing the environmental changes; a control device configured to control the environmental changes and provide environmental information that describes the environmental changes; a data collection device comprising: a unit data storage device that receives and stores the measurements provided by the one or more units and the environmental information provided by the control device; a processing unit that executes code that causes the processing unit to: compute residuals for the operation of the one or more units based on the measurements and the environmental information; compute a stochastic model for the operation of the one or more units based on the computed residuals and the environmental information; and apply the stochastic model to the measurements provided by the one or more units.

Example 19 includes the system of Example 18, wherein the processing unit is further configured to execute code that causes the processing unit to compute a deterministic model based on the stored measurements and the provided environmental information, wherein the one or more units are calibrated using the deterministic model and the residuals are calculated based on measurements provided by the calibrated one or more units.

Example 20 includes the system of any of Examples 18-19, wherein the stochastic model provides an expected value for at least one of: in-run variation, wherein the stochastic model for the in-run variation is calculated based on a temperature dependency for the in-run variation and a correlation of the in-run variation with time; and turn-on variation, wherein the stochastic model for the turn-on variation is calculated based on the residuals calculated at a known time; a current time; and performance maintenance and life testing (PMLT) data gathered from other units belonging to the family of the one or more units.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system comprising:
a storage medium configured to store measurements received from one or more units located within a controlled environment, wherein the controlled environment provides environmental information about the environmental changes experienced by the one or more units; and
a processing unit configured to execute code that causes the processing unit to:
calculate residuals based on the stored measurements and the provided environmental information; and
calculate a stochastic model for the one or more units based on the calculated residuals and the provided environmental information;
wherein the stochastic model is applied to the measurements of the one or more units.

2. The system of claim 1, wherein the processing unit is further configured to execute code that causes the processing unit to compute a deterministic model based on the stored measurements and the provided environmental information, wherein the one or more units are calibrated using the deterministic model and the residuals are calculated based on measurements provided by the calibrated one or more units.

3. The system of claim 1, wherein the stochastic model provides an expected value for at least one of:
in-run variation; and
turn-on variation.

4. The system of claim 3, wherein the stochastic model for the in-run variation is calculated based on a temperature dependency for the in-run variation and a correlation of the in-run variation with time.

5. The system of claim 3, wherein the stochastic model for the turn-on variation is calculated based on:
the residuals calculated at a known time;
a current time; and
performance maintenance and life testing (PMLT) data gathered from other units belonging to the family of the one or more units.

6. The system of claim 1, wherein the one or more units are at least one of:
a gyroscope; and
an accelerometer.

7. The system of claim 1, wherein the environmental information describes at least one of:
an environmental temperature;
a rate of environmental temperature change;
a rate of acceleration; and
a rate of rotation.

8. The system of claim 7, wherein the stochastic model is further calculated based on at least one of:
a measurement of sensor motor drive characteristics;
a time from start of operation for the one or more units;
a magnetic field measurement;
an acoustic field measurement; and
a time since computation of a deterministic model for the one or more units.

9. A method comprising:
compute residuals for the operation of one or more units based on measurements provided by the one or more units within a controlled environment and environmental information about the environmental changes experienced by the one or more units;
compute a stochastic model for the operation of the one or more units based on the computed residuals and the provided environmental information; and
apply the stochastic model to the measurements provided by the one or more units.

10. The method of claim 9, further comprising computing a deterministic model based on the stored measurements and the provided environmental information.

11. The method of claim 10, wherein computing residuals for the operation of the one or more units comprises:
calibrating the one or more units using the deterministic model; and
comparing measurements provided by the calibrated one or more units and expected measurements based on the environmental changes.

12. The method of claim 9, wherein the stochastic model provides an expected value for at least one of:
in-run variation; and
turn-on variation.

13. The method of claim 12, wherein computing the stochastic model for the in-run variation comprises calculating the stochastic model based on a temperature dependency for the in-run variation and a correlation of the in-run variation with time.

14. The method of claim 12, wherein computing the stochastic model for the turn-on variation comprises calculating the stochastic model based on:
the residuals calculated at a known time;
a current time; and
performance maintenance and life testing (PMLT) data gathered from other units belonging to the family of the one or more units.

15. The method of claim 9, wherein the one or more units are at least one of:
a gyroscope; and
an accelerometer.

16. The method of claim 9, wherein the environmental information describes at least one of:
an environmental temperature;
a rate of environmental temperature change;
a rate of acceleration; and
a rate of rotation.

17. The method of claim 16, wherein computing the stochastic model is based on at least one of:
a measurement of sensor motor drive characteristics;
a time from start of operation for the one or more units;
a magnetic field measurement;
an acoustic field measurement; and
a time since computation of a deterministic model for the one or more units.

18. A system comprising:
a controlled environment containing one or more units, wherein the one or more units are exposed to environmental changes and the one or more units provide measurements while experiencing the environmental changes;
a control device configured to control the environmental changes and provide environmental information that describes the environmental changes;
a data collection device comprising:
a unit data storage device that receives and stores the measurements provided by the one or more units and the environmental information provided by the control device;
a processing unit that executes code that causes the processing unit to:
compute residuals for the operation of the one or more units based on the measurements and the environmental information;
compute a stochastic model for the operation of the one or more units based on the computed residuals and the environmental information; and
apply the stochastic model to the measurements provided by the one or more units.

19. The system of claim 18, wherein the processing unit is further configured to execute code that causes the processing unit to compute a deterministic model based on the stored measurements and the provided environmental information, wherein the one or more units are calibrated using the deterministic model and the residuals are calculated based on measurements provided by the calibrated one or more units.

20. The system of claim 18, wherein the stochastic model provides an expected value for at least one of:
in-run variation, wherein the stochastic model for the in-run variation is calculated based on a temperature dependency for the in-run variation and a correlation of the in-run variation with time; and
turn-on variation, wherein the stochastic model for the turn-on variation is calculated based on the residuals calculated at a known time; a current time; and performance maintenance and life testing (PMLT) data gathered from other units belonging to the family of the one or more units.
